(19) United States
(12) Patent Application Publication
(10) Pub. No.: US 2004/0015885 A1
(43) Pub. Date: Jan. 22, 2004

(54) Emulator and emulation method

(76) Inventor: Hiroshi Akatsuka, Tokyo (JP)

Correspondence Address: BURNS DOANE SWECKER & MATHIS L L P, POST OFFICE BOX 1404, ALEXANDRIA, VA, 22313-1404, US

(21) Appl. No.: 09/972,903

(22) Filed: Oct. 10, 2001

(30) Foreign Application Priority Data
Mar. 26, 2001 (JP) 2001-88363

(51) Int. Cl. G06F 9/44; G06F 9/455

(52) U.S. Cl. 717/134; 703/23

(57) ABSTRACT

An emulator comprises a receiving unit for receiving circuit data used for implementing debugging functions, a storage unit for storing the circuit data received by the receiving unit therein, and an emulation unit for performing emulation according to the circuit data stored in the storage unit. The receiving unit can receive a piece of firmware that controls operations of the emulation unit. The emulator can change a use of a hardware resource by updating the circuit data stored in the storage unit. The receiving unit can receive the circuit data from a personal computer. As an alternative, the receiving unit can download the circuit data from a homepage.

### BACKGROUND OF THE INVENTION

1. Field of the Invention

The present invention relates to an emulator and emulation method used for development of a program written for microcomputers.

2. Description of the Prior Art

FIG. 5 is a diagram showing the structure of a system which employs a prior art emulator. In the figure, reference numeral 1 denotes an emulator that consists of a logic circuit such as an IC, reference numeral 2 denotes a personal computer that performs a debugging operation by using functions of the emulator 1, reference numeral 3 denotes an emulator debugger that operates on the personal computer 2 and that is a piece of software for controlling the emulator 1, and reference numeral 4 denotes a communications interface cable that connects between the personal computer 2 and the emulator 1. The communications interface cable 4 can be an RS232C cable, a USB cable, an LPT parallel cable, or the like.

The prior art emulator 1 consists of logic circuits such as ICs. Therefore, when a change is made to the specifications after the development (circuit design) is completed (for example, when an emulator function is upgraded), it is necessary to design the circuits including circuit boards again. Furthermore, when updating or changing a function of the emulator 1 after shipment of a product, it is necessary to collect and modify the product to change the logic.

A problem with a prior art emulator constructed as above is that a change which is made to the specifications after the development (circuit design) is completed causes a necessity to do the circuit design again, and therefore much time and a lot of money are spent in doing that. Furthermore, when trouble or the like occurs after completing shipment of a product, there is a necessity to collect and modify the product. Therefore, while the manufacturer requires a lot of money to modify the product, the user requires time to send the product back to the manufacturer and cannot make use of the product within a time period during which the product is being modified by the manufacturer.

### SUMMARY OF THE INVENTION

The present invention is proposed to solve the above-mentioned problems, and it is therefore an object of the present invention to provide an emulator and emulation method capable of easily changing and updating the specifications covering debugging functions thereof.

In accordance with an aspect of the present invention, there is provided an emulator comprising: a receiving unit for receiving circuit data used for implementing debugging functions; a storage unit for storing the circuit data received by the receiving unit therein; and an emulation unit for performing emulation according to the circuit data stored in the storage unit. Accordingly, the present invention provides an advantage of being able to easily change and update the specifications covering the debugging functions.

In accordance with another aspect of the present invention, the receiving unit receives a piece of firmware that controls operations of the emulation unit. Accordingly, the present invention provides an advantage of being able to update the circuit data even though the type of an MCU is changed.

In accordance with a further aspect of the present invention, the emulator further comprises a unit for changing a use of a hardware resource by updating the circuit data stored in the storage unit. Accordingly, the present invention provides an advantage of being able to allow the user to customize the debugging functions.

In accordance with another aspect of the present invention, the receiving unit receives the circuit data from a personal computer. Accordingly, the present invention provides an advantage of being able to update the circuit data.

In accordance with a further aspect of the present invention, the receiving unit downloads the circuit data from a homepage. Accordingly, the present invention provides an advantage of being able to update the circuit data.

In accordance with another aspect of the present invention, there is provided an emulation method comprising the steps of: receiving circuit data used for implementing debugging functions; storing the circuit data in a memory; and performing emulation according to the circuit data. Accordingly, the present invention provides an advantage of being able to easily change and update the specifications covering the debugging functions.

In accordance with a further aspect of the present invention, the emulation method further comprises the step of receiving a piece of firmware that controls the emulation. Accordingly, the present invention provides an advantage of being able to update the circuit data even though the type of an MCU is changed.

In accordance with another aspect of the present invention, the emulation method further comprises the step of changing a use of a hardware resource by updating the circuit data. Accordingly, the present invention provides an advantage of being able to allow the user to customize the debugging functions.

In accordance with a further aspect of the present invention, the circuit data receiving step is the step of receiving the circuit data from a personal computer. Accordingly, the present invention provides an advantage of being able to update the circuit data.

In accordance with another aspect of the present invention, the circuit data receiving step is the step of downloading the circuit data from a homepage. Accordingly, the present invention provides an advantage of being able to update the circuit data.

Further objects and advantages of the present invention will be apparent from the following description of the preferred embodiments of the invention as illustrated in the accompanying drawings.

### BRIEF DESCRIPTION OF THE DRAWINGS

FIG. 1 is a block diagram showing the structure of an emulator according to a first embodiment of the present invention;

FIG. 2 is a block diagram showing the structure of a shared circuit board unit;

FIG. 3 is a flow chart showing an emulation method according to the first embodiment of the present invention;

FIG. 4 is a diagram showing a problem with a prior art emulator; and

FIG. 5 is a diagram showing a system which employs a prior art emulator.

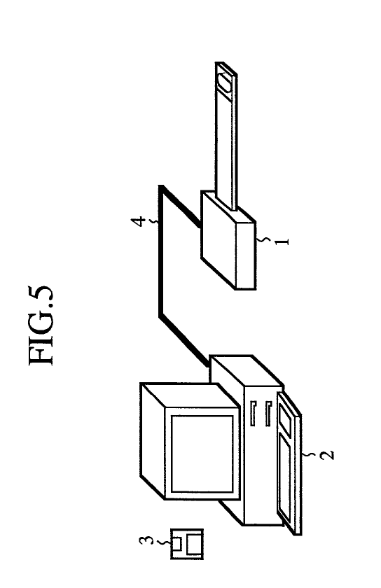

### DETAILED DESCRIPTION OF THE PREFERRED EMBODIMENTS

Embodiment 1.

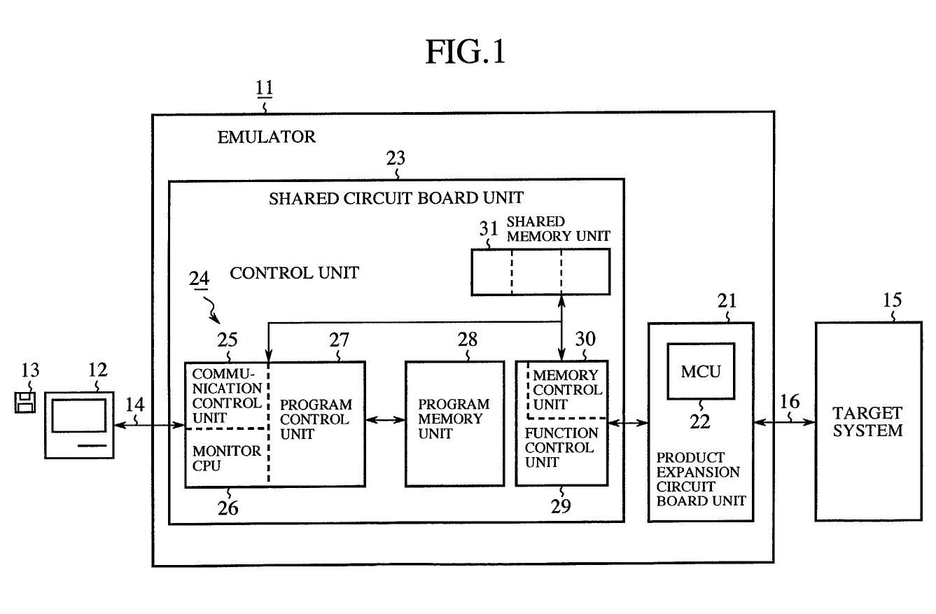

FIG. 1 is a block diagram showing the structure of an emulator according to a first embodiment of the present invention. In the figure, reference numeral 11 denotes an emulator used for development of a program written for microcomputers, reference numeral 12 denotes a personal computer that performs a debugging operation by using functions of the emulator 11, reference numeral 13 denotes an emulator debugger that operates on the personal computer 12 and that is a piece of software for controlling the emulator 11, and reference numeral 14 denotes a communications interface cable that connects between the personal computer 12 and the emulator 11. The communications interface cable 14 can be an RS232C cable, a USB cable, an LPT parallel cable, or the like. Furthermore, reference numeral 15 denotes a target system which is the target to be debugged by the user, and reference numeral 16 denotes an user interface cable that connects between the emulator 11 and the target system 15.

Reference numeral 21 denotes a circuit board unit for product expansion (refereed to as product expansion circuit board unit from here on), which is a block to be newly developed when a new product of an MCU 22 is expanded. The MCU 22 is mounted on the product expansion circuit board unit 21 and is the target to be debugged. Reference numeral 23 denotes a shared circuit board unit that is a block which does not depend on the product expansion of the MCU 22 (i.e., development of a new product of the MCU), reference numeral 24 denotes a control unit for controlling communication between the emulator and the personal computer 12 and the emulation functions, and reference numeral 25 denotes a communications control unit (receiving means) for controlling communication with the personal computer 12 so as to receive a piece of firmware for controlling operations of a monitor CPU 26 and circuit data used for implementing debugging functions from the personal computer 12. The monitor CPU (emulation means) 26 controls the MCU 22 and other internal circuits within the emulator 11 to implement the debugging functions. Reference numeral 27 denotes a program control unit that writes the circuit data received by the communications control unit 25 into a function control unit 29, and reference numeral 28 denotes a program memory unit for storing the firmware and the circuit data received by the communications control unit 25 therein. The function control unit (storage means and emulation means) 29 consists of a programmable device, and implements executive control of the MCU 22 (user program execution, single step execution, debugging program execution, etc.) according to the circuit data written thereinto by the program control unit 27 and the emulation functions (a tracing function, a hardware break detection function, a RAM monitoring function, etc.). Reference numeral 30 denotes a memory control unit for controlling memory access to a shared memory unit 31. The shared memory unit 31 stores information (for example, trace results, coverage information, and RAM monitoring information) required for implementing the debugging functions.

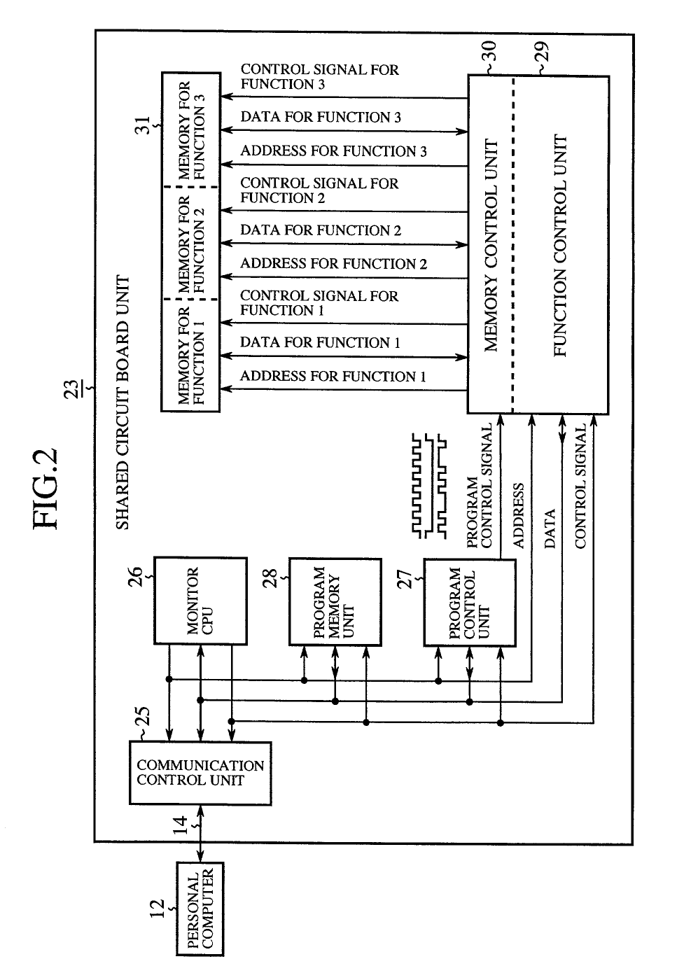

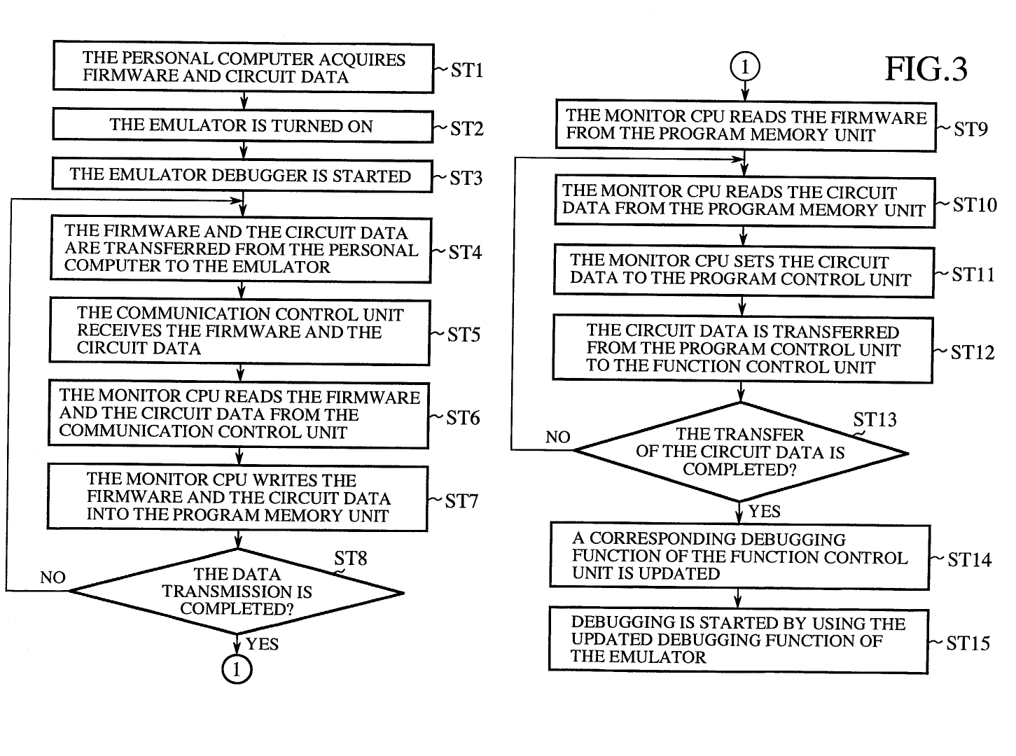

FIG. 2 is a block diagram showing the structure of the shared circuit board unit 23, and FIG. 3 is a flow chart showing an emulation method according to the first embodiment of the present invention.

In operation, a user, in step ST1, operates the personal computer 12 first so as to download a piece of firmware that controls the operation of the monitor CPU 26 and circuit data used for implementing the debugging functions from a homepage or the like. When acquiring the firmware and the circuit data, the user then, in step ST2, turns on the power supply of the emulator 11 and, in step ST3, starts the emulator debugger 13. When the emulator debugger 13 is started, the personal computer 12, in step ST4, transfers the firmware and the circuit data which it has acquired to the emulator 11 by way of the communications interface cable 14.

The communications control unit 25 of the emulator 11, in step ST5, receives the firmware and the circuit data transmitted from the personal computer 12. The communications control unit 25 of the emulator 11 can download the firmware and the circuit data directly from a homepage or the like, instead of receiving them from the personal computer 12. When the communications control unit 25 receives the firmware and the circuit data, the monitor CPU 26, in step ST6, reads the firmware and the circuit data from the communications control unit 25 and then, in step ST7, stores them in the program memory unit 28. The processes ST4 to ST7 are repeatedly performed in step ST8 until the transfer processing on the firmware and the circuit data by the personal computer 12 is completed.

When the storage of the firmware and the circuit data into the program memory unit 28 is completed, the monitor CPU 26, in step ST9, reads the firmware from the program memory unit 28. The monitor CPU 26 also, in step ST10, reads the circuit data from the program memory unit 28 by executing the firmware, and then, in step ST11, outputs the circuit data to the program control unit 27. When the program control unit 27 receives the circuit data from the monitor CPU 26, the program control unit 27, in step ST12, converts the circuit data into data in a format which the function control unit 29 can receive, and then transfers the circuit data in the format to the function control unit 29 so as to write the circuit data into the function control unit 29. The format of the circuit data which the function control unit 29 can receive depends on a device which is used as the function control unit 29. For example, when a programmable FPGA is used as the function control unit 29, the program control unit 27 may convert the received circuit data into serial data so as to deliver it as a program control signal to the function control unit 29. As an alternative, the program control unit 27 can generate and deliver program control signals, such as a chip selection signal and a write signal, to the function control unit 29 by way of a bus for use with the monitor CPU 26. The processes ST10 to ST12 are repeatedly performed in step ST13 until the transfer processing on the circuit data by the program control unit 27 is completed.

When the transfer processing on the circuit data by the program control unit 27 is completed, the function control unit 29, in step ST14, updates the debugging functions. When the debugging functions of the function control unit 29 are updated, the monitor CPU 26, in step ST15, performs debugging of the MCU 22 and the target system 15 by using the updated debugging functions.

As mentioned above, in accordance with the first embodiment of the present invention, the emulator receives circuit data from the personal computer 12, writes the circuit data into the function control unit 29, and performs emulation according to the circuit data. Accordingly, the first embodiment provides an advantage of being able to easily change and update the specifications covering the debugging functions. In other words, the emulator of the first embodiment of the present invention makes it possible to easily change and update the specifications covering the debugging functions without doing circuit design again.

Embodiment 2.

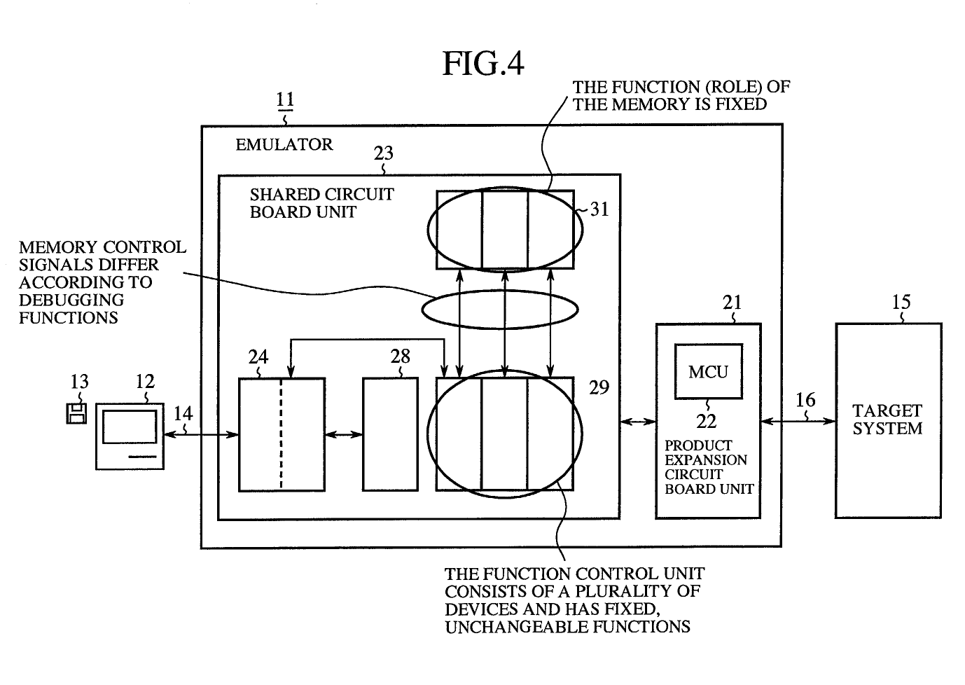

In the prior art, it is necessary to prepare hardware resources required to implement debugging functions according to the debugging functions. For example, to implement a real-time tracing function, a RAM monitoring function, a coverage measurement function, an extension to an emulation memory, and so on, memories are required to store information according to those debugging functions. This is because an address, data, and a control signal for each memory differ according to the debugging functions. A problem is that transfer of a hardware resource (for example, a shared memory unit 31), which is subdivided according to the debugging functions, to another function causes an increase in the size of a function control unit 29 (see FIG. 4).

The application of this concept (i.e., transfer of a hardware resource to another function) makes it possible to assign a circuit (a memory or the like) that implements a function which the user does not use to a function which the user requires only by updating circuit data used for implementing the debugging functions. In accordance with a second embodiment, an emulator can facilitate addition or extension of a function which the user requires (e.g., a trade-off between functions or customization of a function which the user requires) only by updating the circuit data, without increase in the size of the function control unit 29.

By changing circuit data to be transferred to the function control unit 29, the same memory (for example, the shared memory unit 31) can be used as a memory intended for tracing, a memory intended for RAM monitoring, or a memory intended for coverage according to the user's needs. In other words, a function that the user desires to use can be added to the shared memory unit 31, or the shared memory unit 31 is enhanced so that it has a function that the user desires to use. For example, only updating of the circuit data makes it possible to change address, data, and control signal lines intended for functions 1, 2, and 3 as shown in FIG. 2 to different signal lines intended for other functions that the user desires to use. The fact that the signal lines intended for the functions 1, 2, and 3 can be changed indicates the fact that the corresponding memory functions intended for the functions 1, 2, and 3 can be changed.

Hereafter, a description will be made as to the operation of the emulator according to the second embodiment of the present invention.

(a) Circuit data is prepared for each debugging function since the memory control unit 30 that controls the shared memory unit 31 operates in different ways according to debugging functions provided.

(b) The user selects a function necessary for debugging from now on through an emulator debugger 13. For example, when using a RAM monitoring function from now on, the user selects a RAM monitor.

(c) The emulator debugger 13 selects circuit data used for implementing the RAM monitoring function from among a collection of circuit data, and then transfers the selected circuit data to an emulator 11.

(d) A program control unit 27 of the emulator 11 writes the circuit data used for implementing the RAM monitoring function into the function control unit 29. The writing of the circuit data implements the RAM monitoring function in the function control unit 29.

The memory control unit 30 of the function control unit 29 functions as a memory control unit intended for RAM monitoring, and generates and outputs a RAM monitoring control signal to the shared memory unit 31. Therefore, the shared memory unit 31 functions as a memory intended for RAM monitoring.

(e) The monitor CPU 26 can thus implement the RAM monitoring function of the emulator by using the function control unit 29 and the shared memory unit 31.

Many widely different embodiments of the present invention may be constructed without departing from the spirit and scope of the present invention. It should be understood that the present invention is not limited to the specific embodiments described in the specification, except as defined in the appended claims.

What is claimed is:

1. An emulator comprising:
a receiving means for receiving circuit data used for implementing debugging functions;
a storage means for storing the circuit data received by said receiving means therein; and
an emulation means for performing emulation according to the circuit data stored in said storage means.

2. The emulator according to claim 1, wherein said receiving means receives a piece of firmware that controls operations of said emulation means.

3. The emulator according to claim 1, further comprising a means for changing a use of a hardware resource by updating the circuit data stored in said storage means.

4. The emulator according to claim 2, further comprising a means for changing a use of a hardware resource by updating the circuit data stored in said storage means.

5. The emulator according to claim 1, wherein said receiving means receives the circuit data from a personal computer.

6. The emulator according to claim 2, wherein said receiving means receives the circuit data from a personal computer.

7. The emulator according to claim 3, wherein said receiving means receives the circuit data from a personal computer.

8. The emulator according to claim 1, wherein said receiving means downloads the circuit data from a homepage.

9. The emulator according to claim 2, wherein said receiving means downloads the circuit data from a homepage.

10. The emulator according to claim 3, wherein said receiving means downloads the circuit data from a homepage.

11. An emulation method comprising the steps of:
receiving circuit data used for implementing debugging functions;
storing the circuit data in a memory; and
performing emulation according to the circuit data.

12. The emulation method according to claim 11, further comprising the step of receiving a piece of firmware that controls the emulation.

13. The emulation method according to claim 11, further comprising the step of changing a use of a hardware resource by updating the circuit data.

14. The emulation method according to claim 12, further comprising the step of changing a use of a hardware resource by updating the circuit data.

15. The emulation method according to claim 11, wherein said circuit data receiving step is the step of receiving the circuit data from a personal computer.

16. The emulation method according to claim 12, wherein said circuit data receiving step is the step of receiving the circuit data from a personal computer.

17. The emulation method according to claim 13, wherein said circuit data receiving step is the step of receiving the circuit data from a personal computer.

18. The emulation method according to claim 11, wherein said circuit data receiving step is the step of downloading the circuit data from a homepage.

19. The emulation method according to claim 12, wherein said circuit data receiving step is the step of downloading the circuit data from a homepage.

20. The emulation method according to claim 13, wherein said circuit data receiving step is the step of downloading the circuit data from a homepage.
